(19) United States
(12) Patent Application Publication
(10) Pub. No.: US 2024/0088476 A1
(43) Pub. Date: Mar. 14, 2024

(54) MOTOR VEHICLE TRACTION BATTERY MODULE

(71) Applicant: Dr. Ing. h.c. F. Porsche Aktiengesellschaft, Stuttgart (DE)

(72) Inventors: Dominik Grass, Bietigheim-Bissingen (DE); Oliver Steiner, Lehrensteinsfeld (DE); Tim Schmidt, Freiberg am Neckar (DE); Markus Göhring, Nufringen (DE)

(73) Assignee: Dr. Ing. h.c. F. Porsche Aktiengesellschaft, Stuttgart (DE)

(21) Appl. No.: 18/244,976

(22) Filed: Sep. 12, 2023

(30) Foreign Application Priority Data
Sep. 14, 2022 (DE) 10 2022 123 454.1

(51) Int. Cl. H01M 10/6555; B60L 50/64; H01M 10/613; H01M 10/625; H01M 10/647; H01M 10/6557; H01M 10/6567; H01M 50/211; H01M 50/242; H01M 50/249

(52) U.S. Cl. CPC H01M 10/6555; B60L 50/64; H01M 10/613; H01M 10/625; H01M 10/647; H01M 10/6557; H01M 10/6567; H01M 50/211; H01M 50/242; H01M 50/249; H01M 2220/20

(57) ABSTRACT

A motor vehicle traction battery module having a battery housing, in which multiple pouch battery cells are arranged. A plate-shaped cooling structure for direct cooling of the pouch battery cells by a cooling liquid is arranged between two adjacent pouch battery cells. The cooling structure which is compressible in the transverse direction (Y) and perpendicular to its plate plane (xz), includes a first studded plate having a constant plate thickness with a plurality of shaped hollow studs, whose stud peaks contact a side wall of an adjacent pouch battery cell; a second studded plate that is identically shaped to the first studded plate, so that the stud peaks of the second studded plate contact a side wall of the adjacent pouch battery cell; and an elastic pressure structure between the two studded plates, through which the two studded plates are pushed away from one another over their entire surface.

### CROSS-REFERENCE TO RELATED APPLICATION

This application claims priority to German Patent Application No. 10 2022 123 454.1, filed Sep. 14, 2022, the content of such application being incorporated by reference herein in its entirety.

### FIELD OF THE INVENTION

The invention relates to a liquid-cooled motor vehicle traction battery module with an inherently rigid battery housing.

### BACKGROUND OF THE INVENTION

Motor vehicle traction battery modules are so-called high-voltage battery modules with terminal voltages of up to over 1000 V. In order to be able to realize permanently high electrical power output both during charging and during discharging of the traction battery module, the traction battery module must have an internal liquid cooling system. From DE 10 2017 221347 A1, WO 2020 212 652 A1, and EP 3 780 147 A1, which are each incorporated by reference herein, various battery assemblies suitable as motor vehicle traction battery modules having an internal liquid cooling system are known, in which multiple plate-shaped battery cells are installed in an inherently rigid battery housing. The internal liquid cooling is realized by a plate-shaped cooling structure through which a cooling liquid flows, which is arranged in each case between two plate-shaped battery cells.

The so-called pouch battery cells are often used as the battery cells, which, due to their simpler cell structure, have a high electrical efficiency, low manufacturing costs, a high service life, and a high internal thermal conductivity. However, pouch battery cells naturally exhibit significant volume growth over their lifetime.

### SUMMARY OF THE INVENTION

The motor vehicle traction battery module, according to aspects of the invention, is a so-called high-voltage traction battery module with a terminal voltage in the high-voltage range of well over 100 V to over 1000 V. The traction battery module comprises an inherently rigid and crash-resistant battery housing, preferably a metal battery housing. Within the battery housing, multiple plate-shaped pouch battery cells are arranged parallel to one another. In the present case, a pouch battery cell is understood to mean not necessarily a particular type of cell defined physically or chemically, but rather any type of cell that expands significantly during operation, in particular upon heating and/or aging.

A plate-shaped cooling structure is provided between two adjacent pouch battery cells for active and direct liquid cooling of the two pouch battery cells adjoining the cooling structure. In order to give the pouch battery cells space for their expansion, the plate-shaped cooling structure is configured so as to be compressible in the transverse direction and perpendicular to the base plane of the plate-shaped cooling structure or the base plane of the plate-shaped pouch battery cells.

The cooling structure comprises an inherently rigid first studded plate having a constant plate thickness with a plurality of shaped hollow studs, whose outwardly convexly rounded stud peaks or stud peak summits contact a side wall of an adjacent pouch battery cell. Further, the cooling structure comprises an inherently rigid second studded plate that is shaped identically to the first studded plate. The stud peaks of the second studded plate contact one side wall of the adjacent other pouch battery cell. The hollow studs are preferably arranged in a regular distribution pattern. Preferably, each hollow stud has an identical lateral distance from three or four laterally adjacent hollow studs.

An elastic pressure structure is arranged between the two studded plates, through which the two studded plates are pushed away from one another over their entire surface, such that the stud peaks of the two studded plates are respectively pressed against the battery cell side wall with a certain biasing force. Because the pressure structure is elastically compliant, the adjacent battery cells can expand in the transverse direction, compressing the pressure structure, wherein, however, the two studded plates do not deform significantly. The elastic pressure structure can generally be realized in a variety of ways.

A cooling liquid flows between the studded plates and the respective directly adjacent battery cell side wall in stud valleys between the stud peaks, so that the respective battery cell side wall is wetted and cooled directly by the cooling liquid. The aforementioned studs are all fluidly connected to one another, so that a full-surface cooling liquid cavity for the cooling liquid results therefrom. Only in the region of the points of contact between the stud peaks and the directly adjacent battery cell side wall is there no direct contact of the cooling liquid with the battery cell side wall, so that an overall virtually full-surface contact of the cooling liquid with the battery cell side wall is realized.

The two studded plates of the cooling structure are formed rigidly and bend-resistant so that they are not significantly deformed upon expansion of the two pouch battery cells adjacent to them, so that the cooling liquid cavity defined between the respective studded plate and battery cell side wall remains substantially unchanged.

The expansion of the battery cells in the transverse direction is substantially balanced or compensated for exclusively by the elastic pressure structure. This ensures that the maximum available cooling capacity remains virtually unchanged in case of inflated pouch battery cells. For example, the cooling liquid can be a suitable cooling oil that is electrically non-conductive.

Preferably, the two identical studded plates are oriented parallel to one another over their entire surface such that the stud peaks of the first studded plate are aligned in the transverse direction with corresponding stud valleys of the second studded plate. The stud peaks of the one studded plate are all aligned in the transverse direction with the corresponding low points of the stud valleys of the other studded plate. In this way, the two studded plates have approximately the same distance to one another at each point in the transverse direction, so that the elastic pressure structure is also homogeneously compressed and has approximately the same extension in the transverse direction at all points.

Particularly preferably, the studded plates are configured such that the stud peaks and stud valleys of the one studded plate can be nested with the stud valleys and the stud peaks of the other studded plate, i.e. could theoretically be pushed into one another if the pressure structure did not prevent them from doing so. The peaks and valleys of the plates are thus conical, in the broadest or narrowest sense, or correspondingly curved. Without the pressure structure, two studded plates could be placed on top of one another without any spacing, so that there would then be no full-surface distance between the two studded plates.

Particularly preferably, the alternating stud peaks and stud valleys of the studded plate form an approximately sinusoidal profile in cross-section.

In principle, the studded plates can be formed from plastic, for example. Particularly preferably, however, the studded plates are formed from a metal sheet body having a high strength and stiffness, having good thermal conductivity properties, and allowing inexpensive production of the studded plate.

In principle, the spring-elastic pressure structure can be configured in a variety of ways, for example, can be formed by a plurality of individual spring elements. Preferably, the pressure structure is formed from a monolithic, inherently elastic pressure body, for example a foam body with a high permanent resilience. The monolithic pressure body exerts a fully homogeneous pressure on the two studded plates in the transverse direction. A monolithic plastic pressure body can be obtained inexpensively and is easy to use. The pressure body can be glued to the two studded plates, for example.

### BRIEF DESCRIPTION OF THE DRAWINGS

An embodiment example of the invention will be explained in further detail in the following with reference to the figures.

FIG. 1 depicts a schematic longitudinal section of a motor vehicle traction battery module according to aspects of the invention, and

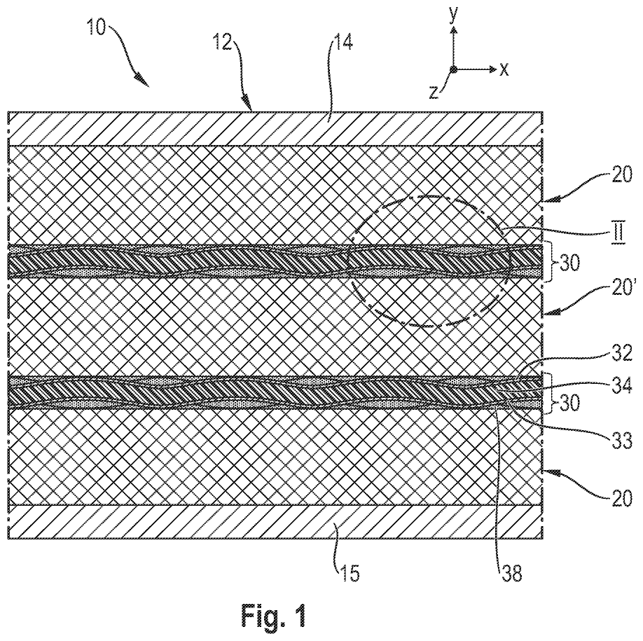

FIG. 2 depicts an enlarged detail of the traction battery module from FIG. 1.

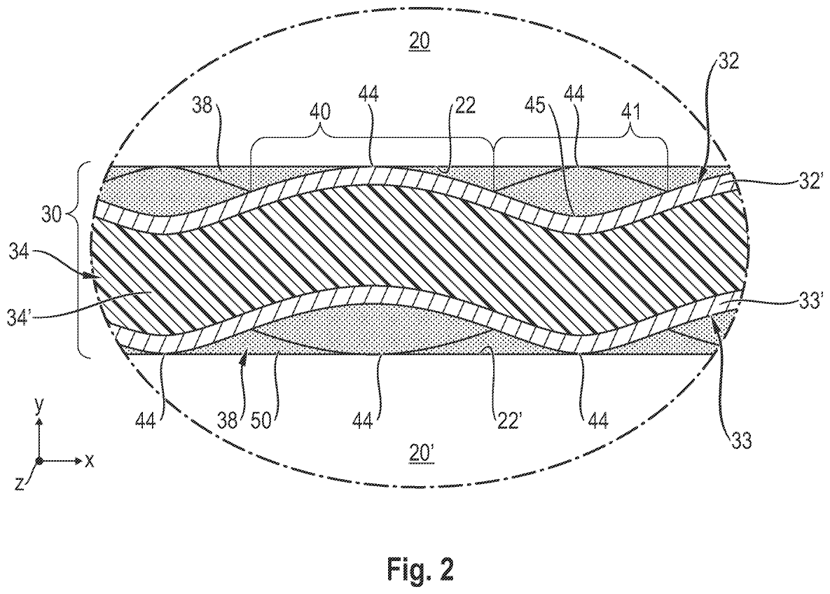

### DETAILED DESCRIPTION OF THE INVENTION

The figures show a schematic longitudinal section of a motor vehicle traction battery module 10, which is a high-voltage battery module having a terminal voltage of, for example, approximately 800 V. In the present case, the traction battery module 10 is only shown schematically, such that in the present case, only three plate-shaped pouch battery cells 20, 20′ are shown in an inherently rigid and crash-resistant metal battery housing 12, by way of example.

However, based on the residual tension of a pouch battery cell 20, 20′, the desired terminal voltage, and the desired traction battery capacity, a corresponding plurality of pouch battery cells are installed in a traction battery module 10. For example, five to ten pouch battery cells can be combined into a cell stack in the battery housing.

The plate-shaped pouch battery cells 20, 20′ lie parallel to one another in a plate plane xz, are identical to one another, and can expand significantly upon heating and by aging in the transverse direction Y. A plate-like cooling structure 30 is arranged between two pouch battery cells 20, 20′ adjacent to one another.

The plate-like cooling structure 30 is arranged between the two pouch battery cells 20, 20′ adjacent to one another such that the two side walls 22, 22′ of the two battery cells 20, 20′ are each cooled over a large surface area directly by a flowing cooling liquid 50. In the present case, the cooling liquid 50 is an electrically non-conductive cooling oil.

The battery housing 12 comprises two metal side walls 14, 15, which are large in area, flat, and parallel to one another and, with their wall planes, lie parallel to the plate planes xz of the battery cells 20, 20′ and the plate-shaped cooling structure 30. The cooling structure 30, which is compressible in the transverse direction y, consists of a first inherently rigid, studded plate 32, a second identical studded plate 33, and a pressure structure 34, which spaces the two studded plates 32, 33 apart from one another and connects them to one another, formed by a monolithic and inherently elastic pressure body 34′. The two studded plates 32, 33 are glued to the pressure body 34′.

Each studded plate 32, 33 is formed by a respective metal sheet body 32′, 33′ and has a virtually constant plate thickness in the transverse direction y over its entire surface. The studded plate 32, 33 defines a plurality of convexly formed hollow studs 40 arranged in a regular technical pattern, whose stud peaks 44 contact the adjacent side wall 22, 22′ of the adjacent pouch battery cell 20, 20′, respectively. As can be seen in the cross-section shown in the figures, the studded plates 32, 33 each have an approximately sinusoidal profile in cross-section. When viewed in the transverse direction y, the stud peaks 44 of the one studded plate 32, 33 are aligned exactly with the corresponding stud valleys 45 of the other studded plate 33, 32, such that the distance between the two studded plates 32, 33 in the transverse direction y is approximately equal at every point.

Due to the fluidly interconnected stud valleys 45, a mesh-like, contiguous cooling liquid cavity 38 is formed between each studded plate 32, 33 and the directly adjacent battery cell side wall 22, 22′, in which cavity the cooling liquid 50 flows so that the respective battery cell side wall 22, 22′ is directly cooled over nearly its entire surface by the cooling liquid 50.

When the pouch battery cells 20, 20′ are expanded in the transverse direction y, the pressure structure 34 elastically compresses, wherein the studded plates 32, 33 remain virtually unchanged in shape, so that the cooling liquid cavities 38 remain virtually unchanged. This ensures that the maximum available cooling capacity remains virtually unchanged even with inflated pouch battery cells 20, 20′.

What is claimed is:

1. A motor vehicle traction battery module comprising:
a battery housing;
two pouch battery cells arranged parallel to one another within the battery housing, each of the pouch battery cells being plate-shaped; and
a cooling structure configured for direct cooling of the pouch battery cells by way of a cooling liquid, the cooling structure being arranged between the two pouch battery cells, wherein the cooling structure is plate-shaped and compressible in a transverse direction (Y) that is perpendicular to a plate plane (X—Z) of the plate-shaped cooling structure,
wherein the cooling structure includes a first studded plate having a substantially constant plate thickness and a plurality of shaped hollow studs formed thereon, each stud having a stud peak that contacts a side wall of a first pouch battery cell of the two pouch battery cells,
wherein the cooling structure includes a second studded plate having a substantially constant plate thickness and a plurality of shaped hollow studs formed thereon, wherein stud peaks of the second studded plate contact a side wall of a second pouch battery cell of the two pouch battery cells,
wherein the cooling structure includes an elastic pressure structure located between the first and second studded plates, the elastic pressure structure being configured to push apart the first and second studded plates over an entire surface of the first and second studded plates,
a first space disposed (i) between the first studded plate and the side wall of the first pouch battery cell, and (ii) in stud valleys between the stud peaks of the first studded plate, such that the cooling liquid may flow in the first space so as to cool by the cooling liquid the side wall of the first pouch battery cell, and
a second space disposed (i) between the second studded plate and the side wall of the second pouch battery cell, and (ii) in stud valleys between the stud peaks of the second studded plate, such that the cooling liquid may flow in the second space so as to cool by the cooling liquid the side wall of the second pouch battery cell.

2. The motor vehicle traction battery module according to claim 1, wherein the first and second studded plates are oriented towards one another over their entire surface, such that the stud peaks of the first studded plate are aligned with the stud valleys of the second studded plate in the transverse direction.

3. The motor vehicle traction battery module according to claim 2, wherein the first and second studded plates are configured such that the stud peaks of the first studded plate are configured to nest within the stud valleys of the second studded plate.

4. The motor vehicle traction battery module according to claim 1, wherein each of the first and second studded plates are formed by a metal sheet body.

5. The motor vehicle traction battery module according to claim 1, wherein each of the first and second studded plates have a substantially sinusoidal profile, as viewed in cross-section.

6. The motor vehicle traction battery module according to claim 1, wherein the elastic pressure structure is formed from a monolithic, elastic pressure body.

7. The motor vehicle traction battery module according to claim 1, wherein the second studded plate and the first studded plate have an identical shape.

8. A motor vehicle traction battery comprising the motor vehicle traction battery module of claim 1.

9. A motor vehicle comprising the motor vehicle traction battery of claim 8.
